(19) United States
(12) Patent Application Publication
(10) Pub. No.: US 2003/0055882 A1
(43) Pub. Date: Mar. 20, 2003

(54) IP network system having providing service control function

(76) Inventor: Nobuhiro Kawamura, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/043,862

(22) Filed: Jan. 9, 2002

(30) Foreign Application Priority Data
Sep. 19, 2001 (JP) 2001-285176

(51) Int. Cl. G06F 15/16

(52) U.S. Cl. 709/203

(57) ABSTRACT

In an IP network system, a providing service control device includes a module for obtaining performance information indicating a state of a traffic congestion from a monitor target network, a module for storing information, as contract data of a contract with a user, showing a service substitutionally providable corresponding to the state of the traffic congestion, and a control module for determining the substitutionally providable service on the basis of the obtained performance information and the contract data, and having the corresponding service provided to a client terminal used by the user. The client terminal includes a module independently obtaining performance information indicating a state of a traffic congestion from the monitor target network, and a module for executing the contract data change request on the basis of the independently obtained performance information.

### BACKGROUND OF THE INVENTION

The present invention relates generally to an IP (Internet Protocol) network system for providing an Internet access service, and more particularly to an IP network system having a providing service control function of restricting, if a state of quality (QoS: Quality of Service) of the network changes due to a traffic congestion in the IP network such as the Internet, an operation (behavior) of a server corresponding to a provider network or an operation of a client terminal used by an end-user in accordance with this change in the state of QoS.

There has been a sharp increase in the number of users (who might be referred to as end-users) of the Internet as an IP network with spreads of personal computers, mobile telephone terminals of i-mode etc and PDAs (Personal Digital Assistants) over the recent years.

A multiplicity of so-called ISPs (Internet Service Providers) for providing a variety of services on the Internet has sprung up, and this has led to a launch into content distribution services for distributing various categories of content data such as music, images and so on.

Under such a background, data sizes of various categories of data transmitted on the Internet will also continue to increase from now into the future. This being the case, in a best effort type network as an IP network (which may be simply termed a network if not strictly specified) utility mode utilized by the great majority of end-users, it is inevitable to cause a decline of quality of the service to be provided due to time-consuming data display on the client terminal used by the end user and an increased access time to a Web site on the Internet when a traffic congestion occurs.

A demand of the end-users is a network environment in which the users can enjoy receiving more stable and higher-quality services without increasing the present costs for utilizing the services.

There is a mechanism to this kind of demand, wherein each carrier (a telecommunication carrier or a service provider) provides a service (QoS) for ensuring a band (a transmission band) predetermined when establishing a contract, and the end-user pays a fixed amount of service utility fee corresponding to this service.

The great majority of end-users utilize the best effort type service in which the end-user receives the standard service by paying only an access fee to the provider while the carrier does not assure the band, this service depending on a state of QoS of the network.

The best effort type service is the mainstream in utilizing the IP network at the present, and the QoS is influenced by the traffic congestion in the network.

When the end-user accesses the Internet in the best effort type service, if the traffic congestion occurs, it is time-consuming till an access screen is displayed on the client terminal used by the end-user, and besides disturbances occurs in the images and sounds in the case of distributing the content data of the images and music.

It is required for keeping the QoS to ensure a certain fixed band, however, an extra service utility fee is also needed.

### SUMMARY OF THE INVENTION

It is a primary object of the present invention to provide a technology capable of keeping a continuity and quickness of providing a service by restricting, if a state of quality (QoS) of an IP network such as the Internet changes due to a traffic congestion therein, an operation (behavior) of a server corresponding to a provider network or an operation of a client terminal used by an end-user in accordance with this change in the state of QoS.

To accomplish the above object, according to one aspect of the present invention, a first providing service control device according to the present invention comprises a module obtaining performance information indicating a state of a traffic congestion from a monitor target network, a module storing information, as contract data of a contract with a user, showing a service substitutionally providable corresponding to the state of the traffic congestion, and a control module determining the substitutionally providable service on the basis of the obtained performance information and the contract data, and having the corresponding service provided to a client terminal used by the user.

In a second providing service control device according to the present invention, the monitor target network may be an IP network including the Internet and a provider network, and the providing service control device may be disposed in the provider network.

In a third providing service control device according to the present invention, the control module may control at least one of a network device and a server within the provider network, and may have the corresponding service provided to the client terminal used by the user.

In a fourth providing service control device according to the present invention, the control module may change at least one of a data size and a data quality of data transmitted by the server to the client terminal as the substitutionally providable service.

In a fifth providing service control device according to the present invention, the changed data to be transmitted by the server to the client terminal may be content data registered previously in the server by a content provider.

In a sixth providing service control device according to the present invention, the control module may have a transmission band of an Internet access line changed that is utilized by the client terminal.

A seventh providing service control device according to the present invention may further comprise a module notifying the client terminal of the obtained performance information.

An eighth providing service control device according to the present invention may further comprise a module receiving a contract data change request that responds to the performance information of which the client terminal has been notified.

According to another aspect of the present invention, a first network system comprises (A) a providing service control device comprising (a) a module obtaining performance information indicating a state of a traffic congestion from a monitor target network, (b) a module storing information, as contract data of a contract with a user, showing a service substitutionally providable corresponding to the state of the traffic congestion, and (c) a control module determining the substitutionally providable service on the basis of the obtained performance information and the contract data, and having the corresponding service provided to a client terminal used by the user, and (B) the client terminal comprising (d) a module independently obtaining performance information indicating a state of a traffic congestion from the monitor target network, and (e) a module executing the contract data change request on the basis of the independently obtained performance information.

In a second network system according to the present invention, the providing service control device may further comprise a module notifying the client terminal of the obtained performance information, and the client terminal may further comprise a module receiving the performance information of which the providing service control device has notified.

In a third network system according to the present invention, the providing service control device may further comprise a module receiving the contract data change request that responds to the performance information of which the client terminal has been notified, and the client terminal may further comprise a module executing the contract data change request based on the performance information of which the providing service control device has notified.

In a fourth network system according to the present invention, the client terminal may further comprise a module controlling the client terminal itself on the basis of any one of the independently obtained performance information and the performance information of which the providing service control device has notified.

In a fifth network system according to the present invention, the monitor target network may be an IP network including the Internet and a provider network, and the providing service control device may be disposed in the provider network.

In a sixth network system according to the present invention, the control module may control at least one of a network device and a server within the provider network, and may have the corresponding service provided to the client terminal used by the user.

In a seventh network system according to the present invention, the control module may change at least one of a data size and a data quality of data transmitted by the server to the client terminal as the substitutionally providable service.

In an eighth network system according to the present invention, the changed data to be transmitted by the server to the client terminal may be content data registered previously in the server by a content provider.

In a ninth network system according to the present invention, the control module may have a transmission band of an Internet access line changed that is utilized by the client terminal

According to a further aspect of the present invention, a providing service control method according to the present invention comprises obtaining performance information indicating a state of a traffic congestion from a monitor target network, storing information, as contract data of a contract with a user, showing a service substitutionally providable corresponding to the state of the traffic congestion, and determining the substitutionally providable service on the basis of the obtained performance information and the contract data, and having the corresponding service provided to a client terminal used by the user.

The respective processes according to the present invention may be provided as a program executable by a computer and be recorded on a recording medium such as a CD-ROM, a floppy disk etc and distributed via communication lines.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a block diagram showing an architecture of an IP network system in one embodiment of the present invention;

FIG. 2 is a block diagram showing detailed architectures of a providing service control device and a client terminal in FIG. 1;

FIG. 3 is an explanatory view showing an outline of an operation in the IP network system in one embodiment of the present invention;

FIG. 4 is a diagram showing an example of a detailed data structure of a contract database of the providing service control device in FIG. 2;

FIG. 5 is a flowchart showing a first processing example of providing service control;

FIG. 6 is a flowchart showing a second processing example of the providing service control;

FIG. 7 is a flowchart showing a third processing example of the providing service control;

FIG. 8 is a flowchart showing a fourth processing example of the providing service control;

FIG. 9 is a flowchart showing a fifth processing example of the providing service control;

FIG. 10 is a flowchart showing a sixth processing example of the providing service control; and

FIG. 11 is a flowchart showing a seventh processing example of the providing service control.

### DETAILED DESCRIPTION OF THE PREFERRED EMBODIMENTS

Embodiments of the present invention will hereinafter be described with reference to the accompanying drawings.

[Architecture of IP Network System]

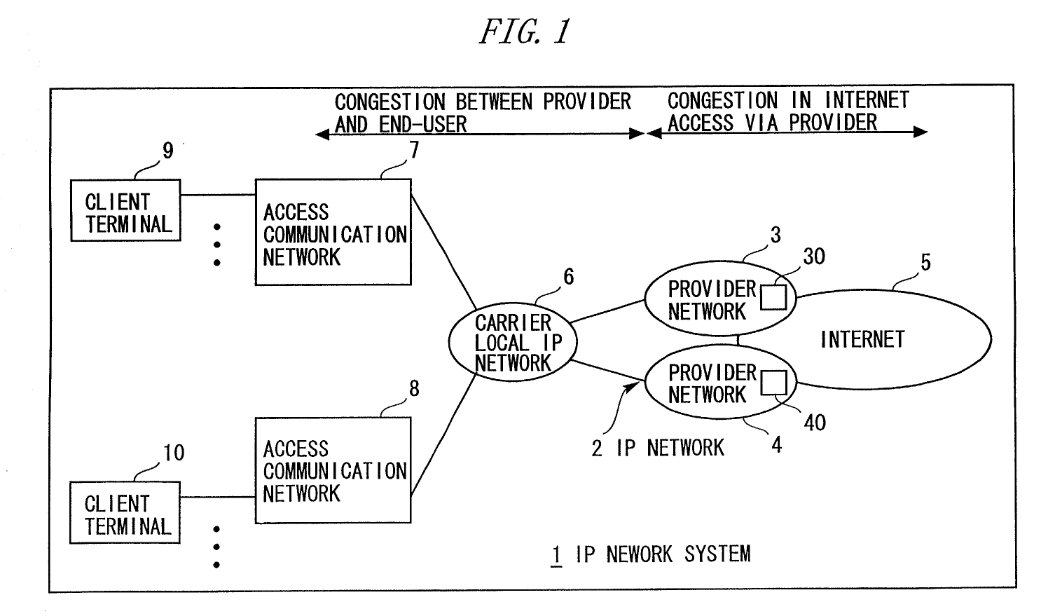

FIG. 1 is a view showing a system architecture in one embodiment of the present invention. Referring to FIG. 1, an IP network system 1 includes a plurality of provider networks 3, 4 that configure an IP network 2, an Internet 5 and a carrier local IP network 6.

These provider networks 3, 4 are each administered and operated by an ISP (Internet Service Provider) and exist at connection points between the Internet 5 and the carrier local IP network 6.

Each of the provider networks 3, 4 leads a client terminal of an end-user who desires for a connection to the Internet 5 into a provider's own telecommunication equipment, whereby the end-user can enjoy various categories of Internet connection services (Internet services) such as distributing contents to the client terminal thereof.

The carrier local IP network 6 is configured by carriers' (telecommunication carriers' or telecommunication service providers') own networks corresponding to local areas such as the Kanto area, the Kansai area and so on. The carrier local IP network 6 as a backbone network accommodates a plurality of unillustrated relay routers and high-speed digital transmission paths.

A plurality of access communication networks 7, 8 are connected to this carrier local IP network 6. Each of the access communication networks 7, 8 includes at least one of a mobile communication network, a fixed telephone network and a router, corresponding to a connection (access) mode of the client terminal used by the end-user.

Pluralities of client terminals 9, 10 used by the end-users are connected to the access communication networks 7, 8, respectively. Each of the client terminals 9, 10 may be, if implementing a communication function, an information display function and an information specifying function, a single unit or a composite unit of a computer terminal such as a personal computer (PC), a mobile telephone terminal and a mobile information terminal such as a PDA (Personal Digital Assistant).

The IP network system 1 described above has a providing service control function of, if a state of quality (QoS: Quality of Service) of the IP network 2 changes due to a traffic congestion in the IP network 2 embracing the provider networks 3, 4, the Internet 5 and the carrier local IP network 6 (which is strictly the congestion occurred under conditions embracing the access communication networks 7, 8), providing a service corresponding to the state of QoS in order to keep a continuity and quickness of providing the service by restricting an operation of an unillustrated server (which might be referred to as an application server) corresponding to the provider network or operations of the end-user client terminals 9, 10 in accordance with the change in the state of QoS.

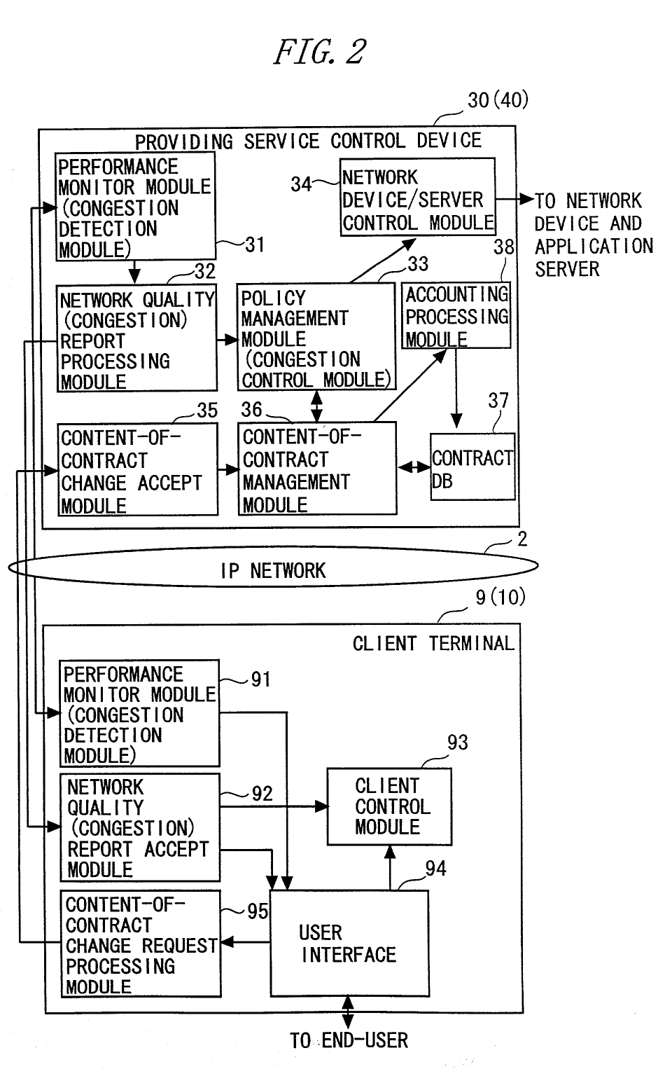

Actualization of this providing service control function corresponding to the state of QoS involves the use of providing service control devices 30, 40 in the provider networks 3, 4. Each of the providing service control devices 30, 40 is, as FIG. 2 shows a detailed architecture thereof, constructed of a performance monitor module (congestion detection module) 31, a network QOS (congestion) report processing module 32, a policy management module (congestion control module) 33, a network device/server control module 34, a content-of-contract change accept module 35, a content-of-contract management module 36, a contract database (DB) 37 and an accounting processing module 38.

Further, for actualizing the providing service control function corresponding to the state of QoS, each of the end-user client terminals 9, 10 includes, as shown in FIG. 2, a performance monitor module (congestion detection module) 91, a network QoS (congestion) report accept module 92, a client control module 93, a user interface module (User Interface) 94 and a content-of-contract change request processing module 95. Note that the illustrations of the access communication networks 7, 8 are omitted in FIG. 2.

[Operation of IP Network System]

(General Description of Operation)

The providing service control device 30 or 40 in the provider network 3 or 4 in the IP network system 1 illustrated in FIG. 1 monitors network performance monitor targets, i.e., as states of QoS, a traffic congestion (a) of the IP network 2 (including the provider network 3 or 4 and the carrier local IP network 6), and a congestion (b) in access to the Internet via the provider (provider network 3 or 4).

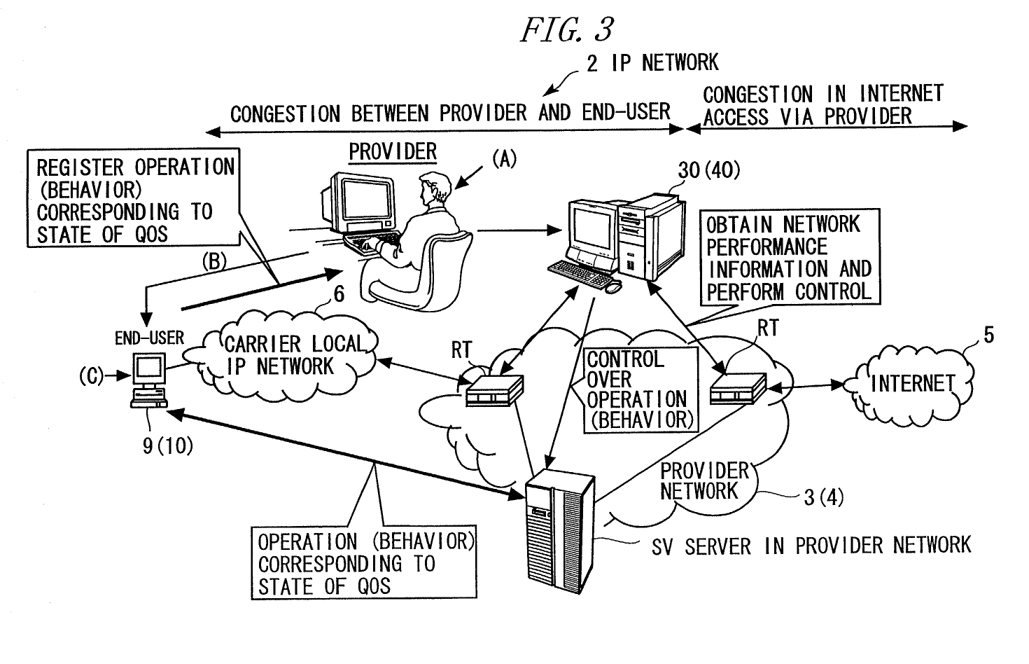

In this IP network system 1, the following operation (behavior) control (A), control (B) and control (C) are executed based on the monitoring of the QoS states (a) and (b). FIG. 3 shows how the control (A), the control (B) and the control (C) are conducted.

The control (A) is that the provider (the providing service control device 30 or 40) monitors the QoS state of the IP network 2, and controls a service level.

The control (B) is that the provider notifies the end-user (the client terminal 9 or 10) of the QoS state of the IP network 2, and controls the service level.

The control (C) is that the end-user monitors the QoS state of the IP network 2, and controls the service level.

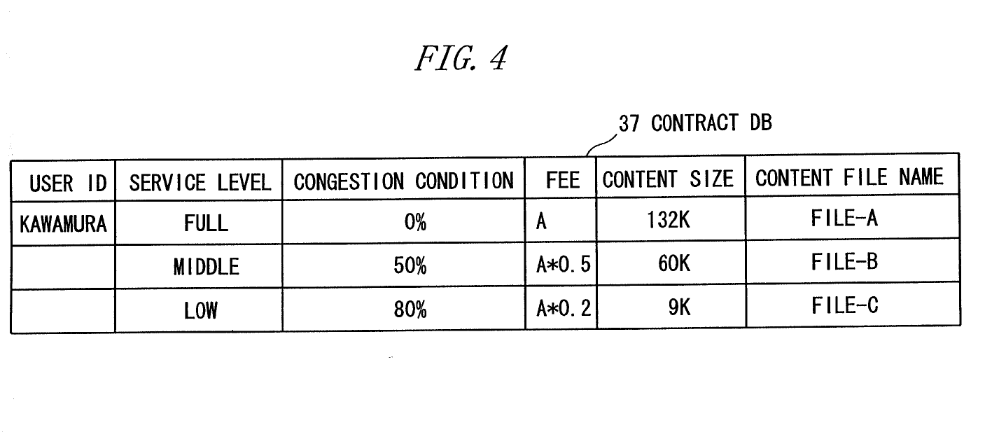

Herein, the service level is a service providing level settled beforehand about which condition the service is provided based on. This service level is, as FIG. 4 shows one example, previously registered corresponding to a user ID (user name), used as key information, of the end-user in the contract database 37 of the providing service control device 30 or 40.

In the example shown in FIG. 4, the contract database 37 is registered with three categories of service levels (Full (high), Middle and Low) corresponding to congestion conditions (occurrence rates) [0%, 50%, 80%], content sizes [132 Kbytes, 60 Kbytes, 9 Kbytes] and content file names [File-A, file-B, File-C], respectively.

(Detailed Description of Operation)

Next, a detailed operation in the IP network system 1 in one embodiment of the present invention will be explained with reference to FIGS. 1 and 2. Note that the following discussion on the operation will be focused on the providing service control device 30 provided in the provider network 3 and on the client terminal 9 used by the end-user, however, the operation is also the same with respect to the providing service control device 40 provided in the provider network 4 and the client terminal 10.

The performance monitor module 31 in the providing service control device 30 disposed in the provider network 3 monitors, as network performance monitor targets, a network QoS state between the provider and the end-user and a network QoS state in the access to the Internet via the provider network.

Information of a performance detected by the performance monitor module 31 is sent to the network quality report processing module 32. The performance information is defined as traffic information such as a data discard ratio, a collision occurrence count and a delay (packet transfer delay time) that are obtained from the IP network 2, and indicates a state of congestion in the IP network.

The network quality report processing module 32 sorts out pieces of performance information sent from the performance monitor module 31 and sends the performance information to the policy management module 33. At the same time, the network quality report processing module 32 notifies the end-user client terminal 9 of the performance information via the IP network 2. Note that a description of intermediary of the IP network 2 between the providing service control device 30 and the client terminal 9 is omitted in the following discussion on the operation.

The policy management module 33 judges based on the performance information whether there is an influence on a content (obtained from a content-of-contract management module 36 as will be explained later on) of the contract agreed upon with the end-user. Then, the policy management module 33 sends a control order defined as an instruction for controlling a network device (indicated by RT in FIG. 3) such as a router to the network device/server control module 34, or a service control request to an application server (indicated by SV in FIG. 3) corresponding to the provider network.

Herein, the content of the contract with the end-user is information that indicates what control should be done when the traffic congestion occurs in the IP network 2. For example, the content of the contract is that if a 50% or larger congestion occurs in the IP network, the content shall be transferred as a file (File-B) having a data size of 60 Kbytes from the application server to the client terminal 9.

The network device/server control module 34 controls the network device and the application server in accordance with an indication given from the policy management module 33.

The content-of-contract management module 36 manages the service level agreed upon beforehand with the end-user, and notifies the policy management module 33 of the content of the contract with the end-user, which is stored in the contract database 37.

The policy management module 33 judges the service level of the service provided to the end-user on the basis of the performance information given from the performance monitor module 31, and issues a service control request to the network device/server control module 34 to control the application server.

The network device/server control module 34, in response to the service control request given from the policy management module 33, controls the application server in accordance with behaviors (contents of service control) as to which service level the service is provided at when the preset traffic congestion occurs in the IP network 2.

The network device/server control module 34 controls (requests) the application server to perform specifically the following three categories of service control.

Rearrangement of Web Sites Opened by Internet Access:

If the end-user tries to open a favorite Web page on the client terminal 9 when the traffic congestion occurs in the IP network 2 it might take a longer time than usual till a screen of the Web page is displayed on the unillustrated display of the client terminal 9 due to a distance to a link Web site and a content size of the Web page itself.

In this case, the network device/server control module 34 controls the application server to rearrange hyperlinks to the access Web sites in a faster accessible sequence in accordance with the QoS state of the IP network 2.

Data Size Control of Data Transmitted from Application Server:

Image data of photos etc are different in data size depending on an image size and a resolution. A content provider is previously stores the application server with the image size of the transfer-target image and the transfer-target content data having a different resolution, and the content having a data size transferable corresponding to the QoS state of the IP network 2 is automatically selected and transferred, whereby the data can be transmitted fast even when the traffic congestion occurs in the IP network 2.

This contrivance makes it possible to meet a demand of the end-user who desires to see the whole content even if the sharpness declines to some extent.

Control of Content of Data Transmitted from Application Server:

The Web page contains graphic data of photos, dynamic images and so on in addition to texts and therefore has a large data size, with the result that it is time-consuming to open a desired Web page when encountering with the traffic congestion in the IP network 2.

A necessary item of information can be obtained without taking up much time for opening the desired Web page by the content provider's sending the content of only the text registered beforehand in accordance with the contract with the end-user.

Further, the content-of-contract management module 36 manages the service level previously agreed upon with the end-user, and notifies the policy management module 33 of the content of the contract with the end-user stored in the contract database in response to a request from the policy management module 33.

The policy management module 33, based on the performance information given from the performance monitor module 31 via the network quality report processing module 32, judges the service level of the service provided to the end-user, and issues a service control request of band control etc over the network device to the network device/server control module 34.

The network device/server control module 34 receiving the request from the policy management module 33 controls the network device in accordance with a content of the requested service control.

The service corresponding to the QoS state of the IP network 2 can be thereby provided. Moreover, a degraded part of data under the specified standard quality can be recorded, accumulated and collected in the contract database 37, whereby the service assuring a high quality can be provided to the end-user.

The network quality report processing module 32 sorts out the performance information obtained by the detection of the performance monitor module 31, and provides the performance information on the IP network 2 to the client terminal 9 of the end-user.

The performance information provided herein is information on the network QoS state between the network performance monitor target provider network and the end-user and on the network QoS state in the Internet access via the provider network.

The end-user is able to confirm a time required for the access to the Web site and a time required for obtaining the necessary item of data depending on the state of the traffic congestion in the IP network 2, and is therefore able to select a destination to which the client terminal 9 is linked by recognizing a displayable time on the client terminal 9.

The end-user receiving a network quality state report indicating a degree of the traffic congestion in the IP network 2 through the network quality report accept module 92 of the client terminal 9 from the providing service control device 30 used by the provider, is able to notify the provider, i.e., the providing service control device 30 of a change in the service level with the help of a content-of-contract changing function provided to the client terminal 9.

A content-of-contract change request given from the client terminal 9 of the end-user is accepted by a content-of-contract change accept module 35 of the providing service control device 30 and is thereafter sent to the content-of-contract management module 36.

The content-of-contract management module 36 changes the content of the contract on the basis of the content-of-contract change request. With this change, the end-user-based contract data stored in the contract database 37 shown in FIG. 4 and specify what service control is done when the traffic congestion occurs in the IP network 2, are updated, and the accounting processing module 38 is notified of this update, thus changing a fee.

Further, the content-of-contract management module 36 notifies the policy management module 33 of the changed content of the contract. Along with the change in the content of the contract, the policy management module 33 changes a rule (policy) about the congestion-related behavior with respect to the network device or the application server.

To be specific, for instance, the end-user receives the service at the service level of [Full (high)] through the client terminal 9. If it is time-consuming to see the content of the desired Web page due to the congestion state, however, the end-user makes a request for changing the service level to [Low]. With this change, though a quality of the content received on the client terminal 9 declines, the content of the desired Web page can be browsed sooner.

The end-user takes the initiative in making the request for changing the service level when the congestion occurs in the IP network 2, and is thereby able to receive the necessary service when necessary.

The performance monitor module 91 of the client terminal 9 is a control module for monitoring the performance in the IP network 2 by the client terminal 9 itself and a performance (e.g., a CPU activity ratio) of the client terminal 9 itself.

The performance monitor module 91 detects pieces of performance information corresponding to the congestion (strictly, the congestion under the condition embracing not only the provider network 3 and the carrier local IP network 6 but also the access communication network 7) in the IP network 2 between the end-user (the client terminal 9) and the provider (the provider network 3), and to the congestion in the Internet access via the provider (the provider network 3).

The end-user using the client terminal 9, after confirming the performance information detected by the performance monitor module 91 on an unillustrated display screen via the user interface 94, requests the providing service control device 30 to change the content of the contract through the content-of-contract change request processing module 95.

The end-user is thereby able to confirm in advance a state of resources of the IP network 2 on the side of the end-user (the client terminal 9) and to set in the provider-sided providing service control device 30 a service level corresponding to the QoS state of the end-user-sided IP network 2.

Further, the end-user using the client terminal 9, after confirming the performance information of the client terminal 9 itself which has been detected by the performance monitor module 91 on the display screen via the user interface 94, indicates the client control module 93 via the user interface to execute the service control of the client terminal 9 itself in accordance with the performance (QoS state) of the client terminal 9 itself.

Herein, the service control executed by the client control module 93 for the client terminal 9 itself involves making image display software (Browser) run on the client terminal 9 to perform such control that if unable to display the content on the display screen in a normal time, none of images contained in the content are displayed, the resolution of the image in the content is decreased, and the image in the content is downsized.

This enables the client terminal 9 to recognize in advance the QoS state and the state of the resources of the IP network 2 and further the performance of the client terminal 9 itself, whereby the service control corresponding to the QoS state on the side of the client terminal 9 can be executed on the side of the client terminal 9.

(Various Processing Examples of Providing Service Control)

Next, various processing examples of the providing service control in the IP network system in one embodiment of the present invention will be explained referring to the related drawings.

### PROCESSING EXAMPLE 1

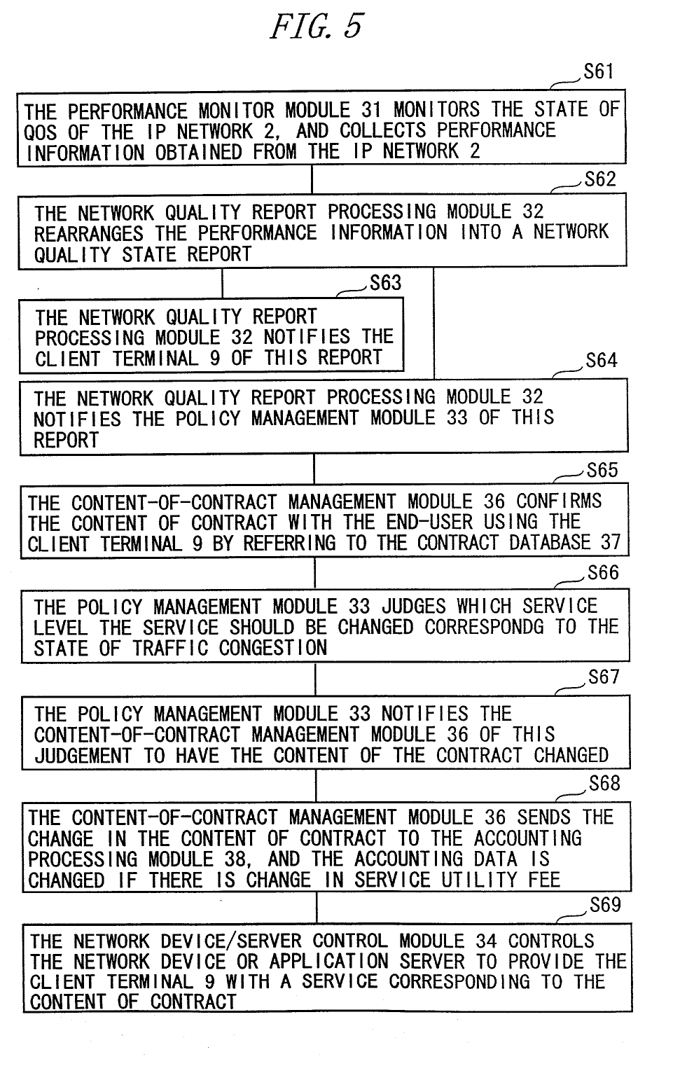

Referring to FIGS. 1, 2, 4 and 5, in the IP network system 1, the performance monitor module 31 of the providing service control device 30 monitors the QoS state of the IP network 2 with respect to the network performance monitor target. The performance monitor module 31 collects pieces of performance information obtained from the IP network 2 as information indicating a state of the traffic congestion in the IP network 2 (S61).

The network quality report processing module 32 rearranges the performance information collected by the performance monitor module 31 into a network quality state report in a format comprehensible to the end-user, and thereafter notifies the end-user client terminal 9 of this report (s62, S63).

Further, the network quality report processing module 32 notifies the policy management module 33 of the network quality state report (S64).

In response to an indication given from the policy management module 33, the content-of-contract management module 36 confirms a content of the contract of the end-user [Kawamura] by referring to the contract database 37 shown in FIG. 4 (S65)

As a result of the confirmation, if the content of the contract with the end-user prescribes an implementation of the service control such as [changing and distributing the content file in accordance with the state of the traffic congestion in the IP network 2] and so on, the policy management module 33 judges from the state of the traffic congestion in the IP network 2 which service level (service control) the present service level should be changed to. Then, the policy management module 33 notifies the content-of-contract management module 36 of this judgement so that the management module 36 changes the content of the contract (S66, S67).

The content-of-contract management module 36 transmits the change in the content of the contract also to the accounting processing module 38, and, if there is a change in service utility fee, the accounting data is changed (S68).

Further, the network device/server control module 34 controls the network device or the application server so as to provide the client terminal 9 with the service corresponding to the changed content of the contract (S69).

With this process, the performance state (QoS state) of the IP network 2 is monitored, and the service control for the end-user using the client terminal 9 can be executed based on the performance information.

### PROCESSING EXAMPLE 2

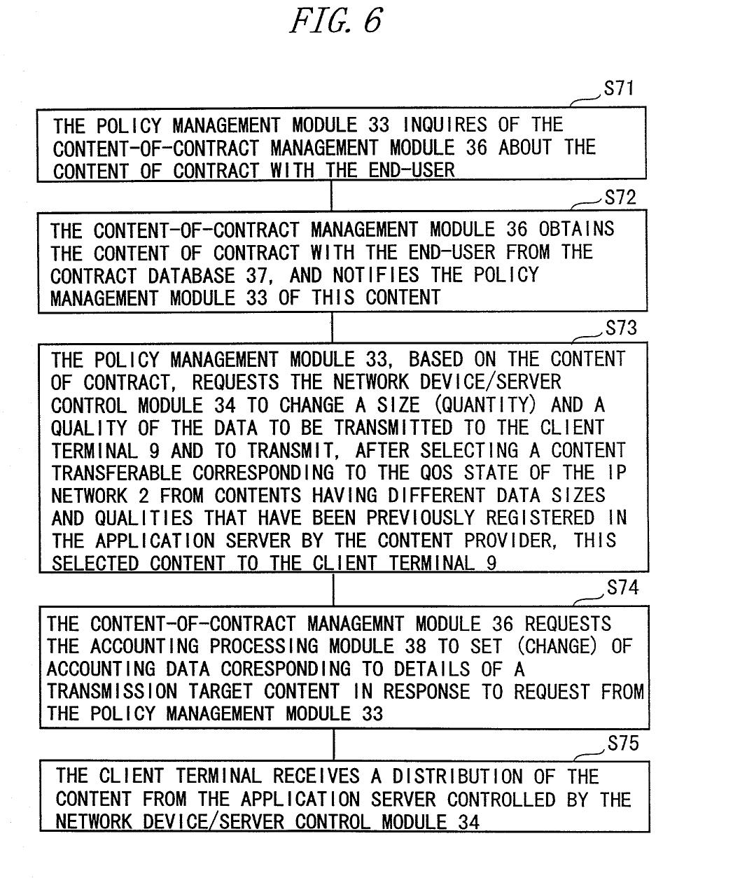

Referring to FIGS. 1, 2 and 6, in the IP network system 1, the policy management module 33 of the providing service control device 30 inquires of the content-of-contract management module 36 about the content of the contract with the end-user (S71).

The content-of-contract management module 36 obtains the relevant content of the contract with the end-user from the contract database 37, and notifies the policy management module 33 of the content of the contract (S72).

The policy management module 33, based on the content of the contract, requests the network device/server control module 34 to change a size (quantity) and a quality of the data to be transmitted to the client terminal 9 used by the end-user, and to transmit, after selecting a content transferable corresponding to the QoS state of the IP network 2 from the contents having different data sizes and qualities that have been previously registered in the application server by the content provider, this selected content to the client terminal 9 (S73).

Further, the content-of-contract management module 36, in response to the request given from the policy management module 33, requests the accounting processing module 38 to set (change) accounting data corresponding to the detail of the transmission target content (S74).

The application server controlled and requested by the network/server control module 34 distributes the content to the client terminal 9 used by the end-user (S75).

Owing to this process, the end-user, even if the IP network 2 falls into the traffic congestion, has no necessity of waiting for a long period of time till the data are displayed on the display screen of the client terminal 9.

### PROCESSING EXAMPLE 3

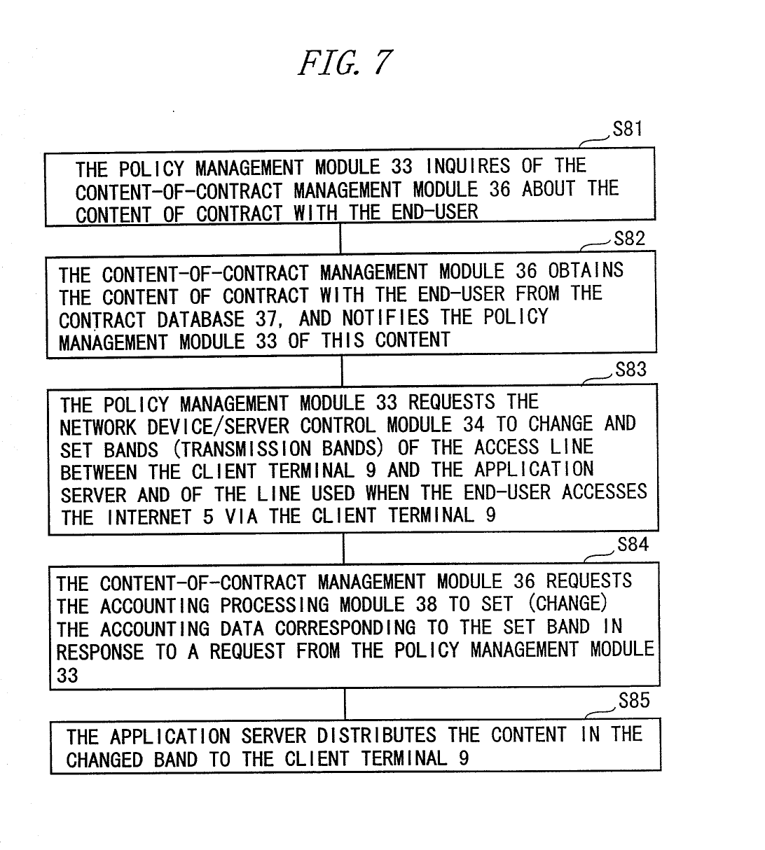

Referring to FIGS. 1, 2 and 7, in the IP network system 1, the policy management module 33 of the providing service control device 30 inquires of the content-of-contract management module 36 about the content of the contract with the end-user (S81).

The content-of-contract management module 36 obtains the relevant content of the contract with the end-user from the contract database 37, and notifies the policy management module 33 of this content (S82).

The policy management module 33, based on the content of the contract, requests the network device/server control module 34 to change and set bands (transmission bands) of a connection line between the end-user client terminal 9 and the application server and of a line used when the end-user accesses the Internet 5 through the client terminal 9 (S83). In response to this request, the network device/server control module 34 controls the router in the provider network 3 to change the band.

Further, the content-of-contract management module 36, in response to the request from the policy management module 33, requests the accounting processing module 38 to set (change) the accounting data corresponding to the set band (S84).

The application server distributes the content in the changed band to the client terminal 9 of the end-user (S85).

With this process, the end-user is able to ensure a substitute band predetermined in the contract even if the IP network 2 falls into the traffic congestion, and has no necessity of waiting for the long period of time till the data are displayed on the display screen of the client terminal 9.

### PROCESSING EXAMPLE 4

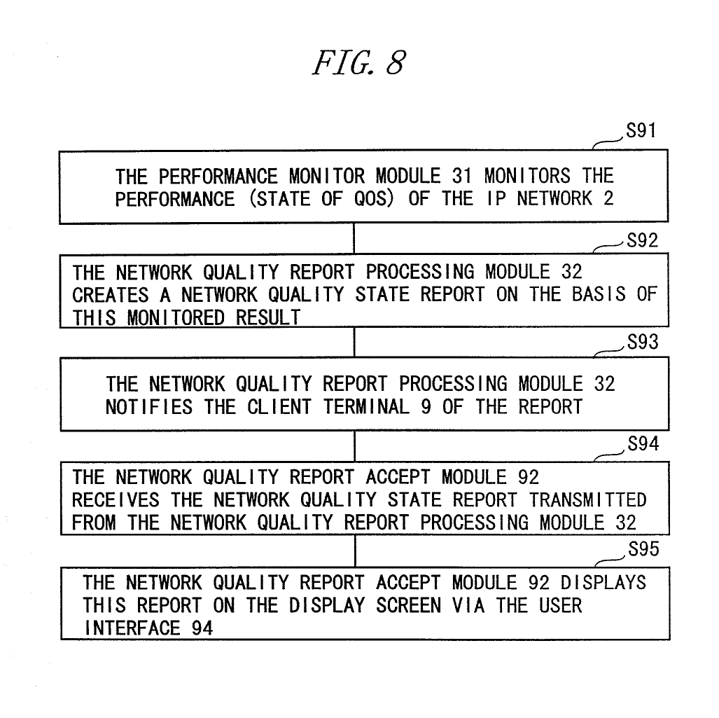

Referring to FIGS. 1, 2 and 8, in the IP network system 1, the performance monitor module 31 of the providing service control device 30 monitors the performance (QoS state) of the IP network 2, and the network quality report processing module 32 creates the network quality state report based on the monitored result and notifies the end-user client terminal of this report (S91, S92, S93).

The network quality report accept module 92 of the client terminal 9 receives the network quality state report transmitted from the network quality report processing module 32, and displays this report on the display screen via the user interface 94 (S94, S95).

With this process, the end-user, i.e., the client terminal 9 is capable of knowing states such as the traffic congestion in the IP network 2, an access time to the Web site on the Internet, and a time required for running the application (application software).

### PROCESSING EXAMPLE 5

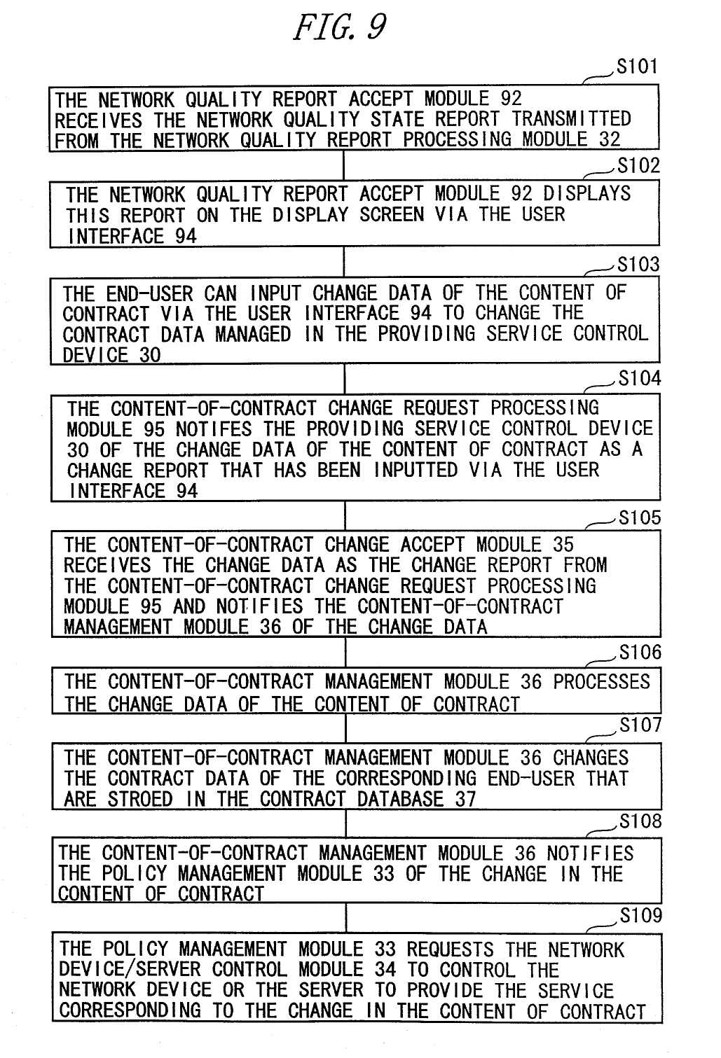

Referring to FIGS. 1, 2 and 9, in the IP network system 1, the network quality report accept module 92 of the client terminal 9 receives the network quality state report transmitted from the network quality report processing module 32, and displays this network quality state report on the display screen via the user interface 94 (S101, S102).

The end-user can input the change data of the content of the contract from an unillustrated input device such as a keyboard via the user interface 94 in order to change the contract data managed in the provider-sided providing service control device 30 (S103).

The content-of-contract change request processing module 95 notifies the provider-sided providing service control device 30 of the change data of the content of the contract as a change report that has been inputted via the user interface 94 (S104).

The content-of-contract change accept module 35 of the providing service control device 30 receives the change data of the content of the contract as the change report from the content-of-contract change request processing module 95, and notifies the content-of-contract management module 36 of this report (S105).

The content-of-contract management module 36 processes the change data of the content of the contract, and changes the contract data of the corresponding end-user that are stored in the contract database 37 (S106, S107).

Further, the content-of-contract management module 36 notifies the policy management module 33 of the change in the content of the contract. Upon receiving this notification, the policy management module 33 requests the network device/server control module 34 to control the network device or the application server so as to provide a service corresponding to the change in the content of the contract (S108, S109).

With this process, the end-user judges the QoS state of the IP network 2 and is able to take the initiative in changing the content of the contract.

### PROCESSING EXAMPLE 6

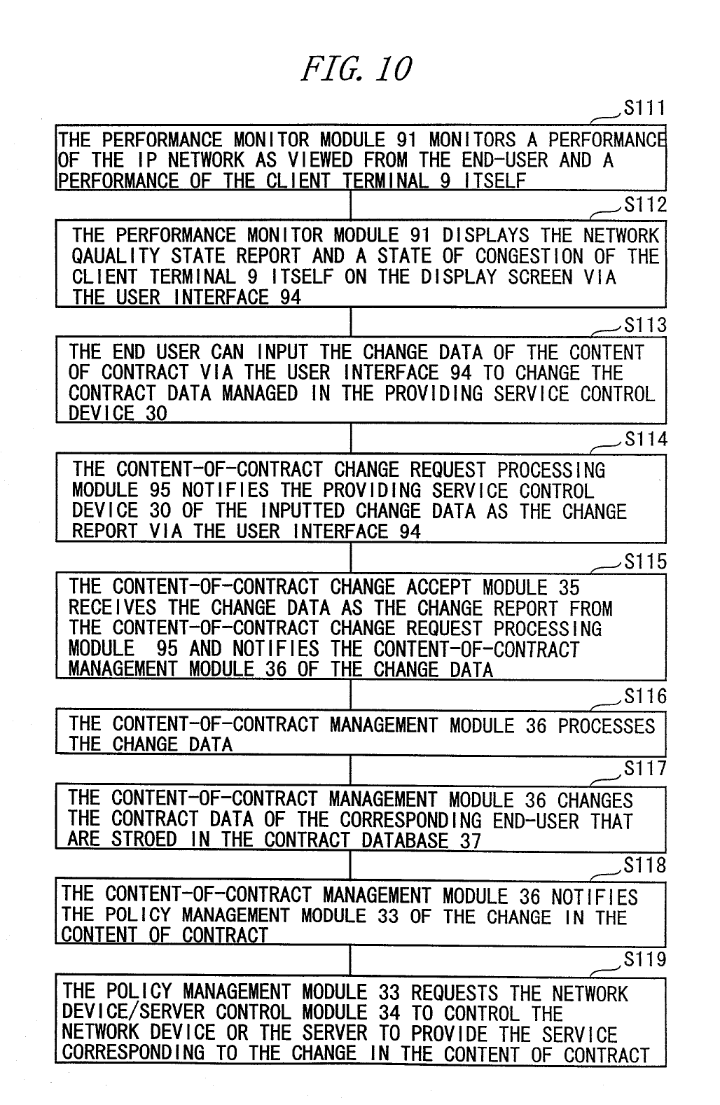

Referring to FIGS. 1, 2 and 10, in the IP network system 1, the performance monitor module 91 of the client terminal 9 monitors the performance of the IP network 2 as viewed from the end-user and the performance (e.g., the CPU activity ratio) of the client terminal 9 itself, and displays the network QoS state report and the congestion state of the client terminal 9 itself on the display screen via the user interface 94 (S111, S112).

The end-user can input the change data of the content of the contract from the input device such as the keyboard via the user interface 94 in order to change the contract data managed in the provider-sided providing service control device 30 (S113).

The content-of-contract change request processing module 95 notifies the provider-sided providing service control device 30 of the change data of the content of the contract as a change report that has been inputted via the user interface 94 (S114).

The content-of-contract change accept module 35 of the providing service control device 30 receives the change data of the content of the contract as the change report from the content-of-contract change request processing module 95, and notifies the content-of-contract management module 36 of this report (S115).

The content-of-contract management module 36 processes the change data of the content of the contract, and changes the contract data of the corresponding end-user that are stored in the contract database 37 (S116, S117).

Further, the content-of-contract management module 36 notifies the policy management module 33 of the change in the content of the contract. Upon receiving this notification, the policy management module 33 requests the network device/server control module 34 to control the network device or the application server so as to provide a service corresponding to the change in the content of the contract (S118, S119).

With this process, the performance of the IP network 2 as viewed from the end-user and the performance of the client terminal 9 itself are monitored, and the end-user is able to take the initiative in changing the content of the contract.

### PROCESSING EXAMPLE 7

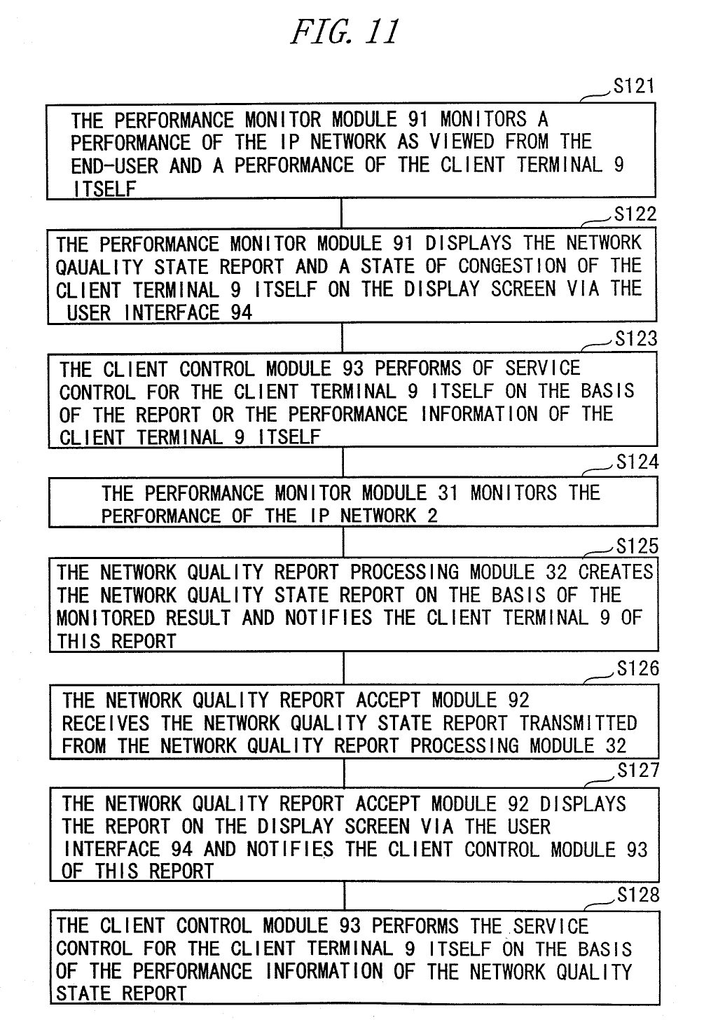

Referring to FIGS. 1, 2 and 11, in the IP network system 1, the performance monitor module 91 of the client terminal 9 monitors the performance of the IP network 2 as viewed from the end-user and the performance of the client terminal 9 itself, and displays the network QoS state report and the congestion state of the client terminal 9 itself on the display screen via the user interface 94 (S121, S122).

The client control module 93 executes the service control for the client terminal 9 itself on the basis of the network QoS state report or the performance information of the client terminal 9 itself (S123).

Herein, the service control executed by the client control module 93 for the client terminal 9 itself involves making the image display software (Browser) run on the client terminal 9 to perform such control that if unable to display the content on the display screen in a normal time, none of images contained in the content are displayed, the resolution of the image in the content is decreased, and the image in the content is downsized.

The end-user can input a selection request of the service control from the input device such as the keyboard via the user interface 94.

Moreover, the performance monitor module 31 of the providing service control device 30 monitors the performance of the IP network 2, and the network quality report processing module 32 creates a network quality state report on the basis of this monitored result and notifies the end-user client terminal 9 of this report (S124, S125).

The network quality report accept module 92 of the client terminal 9 receives the network quality state report sent from the network quality report processing module 32 of the providing service control device 30, then displays this report on the display screen via the user interface 94, and notifies the client control module 93 of this report (S126, S127).

The client control module 93 implements the service control for the client terminal 9 itself on the basis of the performance information in the network quality state report (S128).

With this process, the service control can be attained on the side of the client terminal 9 in accordance with the QoS state of the IP network or the performance information of the client terminal 9 itself.

The respective processes in one embodiment of the present invention discussed above are provided as a program executable by a computer and can be recorded on a recording medium such as a CD-ROM, a floppy disk etc and distributed via communication lines.

It can be expected that the IP network system 1 implementing the providing service control function corresponding to the QoS state in one embodiment of the present invention, exhibits the following effects.

(1) Even if any contract for ensuring the band is not established beforehand, the network device such as the router and the application server corresponding to the provider network can be controlled to execute the service control corresponding to the QoS state of the IP network. The service utility fees to be paid to the Internet service provider (ISP) and other service providers can be retrained low.

(2) The method is not that the necessary band is always ensured but that the service level is controlled corresponding to the QoS state of the IP network. Hence, even the end-user receiving a best effort type service at the present comes to have no necessity of waiting for the long time till the data are displayed on the display screen of the client terminal due to the traffic congestion in the IP network and can enjoy the stable service by changing the service level.

(3) The service control corresponding to the QoS state of the IP network can be conducted, and the high-quality service can he provided to the end-user.

(4) The end-user can know the IP network performance information such as the traffic congestion etc in the IP network and can receive the service corresponding to the QoS state of the IP network.

(5) The end-user can take the initiative in changing the service level and receive the stable service without waiting long for receiving the service conditional on the QoS state of the IP network.

(6) The performance state of the IP network is monitored on the side of the end-user, and the end-user is thereby able to take the initiative in controlling the service level.

(7) The performance state of the IP network is monitored on the side of the end-user, and the service control can be attained on the side of the end-user.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A providing service control device comprising:
a module obtaining performance information indicating a state of a traffic congestion from a monitor target network;
a module storing information, as contract data of a contract with a user, showing a service substitutionally providable corresponding to the state of the traffic congestion; and
a control module determining the substitutionally providable service on the basis of the obtained performance information and the contract data, and having the corresponding service provided to a client terminal used by the user.

2. A providing service control device according to claim 1, wherein said monitor target network is an IP network including the Internet and a provider network, and
said providing service control device is disposed in said provider network.

3. A providing service control device according to claim 1, wherein said control module controls at least one of a network device and a server within a provider network, and has the corresponding service provided to said client terminal used by the user.

4. A providing service control device according to claim 3, wherein said control module changes at least one of a data size and a data quality of data transmitted by said server to said client terminal as the substitutionally providable service.

5. A providing service control device according to claim 4, wherein the changed data to be transmitted by said server to said client terminal are content data registered previously in said server by a content provider.

6. A providing service control device according to claim 3, wherein said control module has a transmission band of an Internet access line changed that is utilized by said client terminal.

7. A providing service control device according to claim 1, further comprising a module notifying said client terminal of the obtained performance information.

8. A providing service control device according to claim 7, further comprising a module receiving a contract data change request that responds to the performance information of which said client terminal has been notified.

9. A network system comprising:
(A) a providing service control device comprising:
(a) a module obtaining performance information indicating a state of a traffic congestion from a monitor target network;
(b) a module storing information, as contract data of a contract with a user, showing a service substitutionally providable corresponding to the state of the traffic congestion; and
(c) a control module determining the substitutionally providable service on the basis of the obtained performance information and the contract data, and having the corresponding service provided to a client terminal used by the user; and
(B)said client terminal comprising:
(d) a module independently obtaining performance information indicating a state of a traffic congestion from said monitor target network; and
(e) a module executing the contract data change request on the basis of the independently obtained performance information.

10. A network system according to claim 9, wherein said providing service control device further comprises a module notifying said client terminal of the obtained performance information, and
said client terminal further comprises a module receiving the performance information of which said providing service control device has notified.

11. A network system according to claim 10, wherein said providing service control device further comprises a module receiving the contract data change request that responds to the performance information of which said client terminal has been notified, and
said client terminal further comprises a module executing the contract data change request based on the performance information of which said providing service control device has notified.

12. A network system according to claim 11, wherein said client terminal further comprises a module controlling said client terminal itself on the basis of any one of the independently obtained performance information and the performance information of which said providing service control device has notified.

13. A network system according to claim 9, wherein said monitor target network is an IP network including the Internet and a provider network, and
said providing service control device is disposed in said provider network.

14. A network system according to claim 9, wherein said control module controls at least one of a network device and a server within a provider network, and has the corresponding service provided to said client terminal used by the user.

15. A network system according to claim 14, wherein said control module changes at least one of a data size and a data quality of data transmitted by said server to said client terminal as the substitutionally providable service.

16. A network system according to claim 15, wherein the changed data to be transmitted by said server to said client terminal are content data registered previously in said server by a content provider.

17. A network system according to claim 14, wherein said control module has a transmission band of an Internet access line changed that is utilized by said client terminal.

18. A providing service control method comprising:
obtaining performance information indicating a state of a traffic congestion from a monitor target network;
storing information, as contract data of a contract with a user, showing a service substitutionally providable corresponding to the state of the traffic congestion; and
determining the substitutionally providable service on the basis of the obtained performance information and the contract data, and having the corresponding service provided to a client terminal used by the user.

19. A providing service control method according to claim 18, further comprising controlling at least one of a network device and a server within a provider network, and having the corresponding service provided to said client terminal used by the user.

20. A providing service control method according to claim 19, further comprising changing at least one of a data size and a data quality of data transmitted by said server to said client terminal as the substitutionally providable service.

21. A providing service control method according to claim 20, wherein the changed data to be transmitted by said server to said client terminal are content data registered previously in said server by a content provider.

22. A providing service control method according to claim 19, further comprising having a transmission band of an Internet access line changed that is utilized by said client terminal.

23. A providing service control method according to claim 18, further comprising notifying said client terminal of the obtained performance information.

24. A providing service control method according to claim 23, further comprising receiving a contract data change request that responds to the performance information of which said client terminal has been notified.

25. A readable-by-computer recording medium recorded with a program read by a computer to execute:
obtaining performance information indicating a state of a traffic congestion from a monitor target network;
storing information, as contract data of a contract with a user, showing a service substitutionally providable corresponding to the state of the traffic congestion; and
determining the substitutionally providable service on the basis of the obtained performance information and the contract data, and having the corresponding service provided to a client terminal used by the user.
